(19) United States
(12) Patent Application Publication
(10) Pub. No.: US 2005/0242472 A1
(43) Pub. Date: Nov. 3, 2005

(54) Process for the moulding of plastics sheets

(76) Inventor: Hubert Goldbach, Ratingen (DE)

Correspondence Address: LANXESS CORPORATION, 111 RIDC PARK WEST DRIVE, PITTSBURGH, PA, 15275-1112, US

(21) Appl. No.: 11/110,166

(22) Filed: Apr. 20, 2005

(30) Foreign Application Priority Data
Apr. 21, 2004 (DE) 1020040192936

(51) Int. Cl. B29C 51/00; B29C 51/42

(52) U.S. Cl. 264/458; 264/544; 264/492

(57) ABSTRACT

A process is described for the moulding of plastics sheets, using a two-part moulding tool. The process encompasses the steps of insertion of the sheet into the moulding tool, closure of the moulding tool, thermoforming of the sheet with exposure to pressure and heat, with shaping against the interior contours of the moulding tool, and cooling of the thermoformed sheet, characterized in that the pressure side of the sheet is treated with a temperature-controlled liquid.

### FIELD OF THE INVENTION

The present invention relates to a process for the moulding of plastics sheets with exposure to pressure, and using a two-part moulding tool.

### BACKGROUND OF THE INVENTION

The low heat resistance of unfilled thermoplastics, and their high coefficient of thermal expansion limit the use of these materials for body work panelling, because the gap dimensions needed are excessive and higher temperatures cause deformation. Glass-fibre-reinforced thermoplastics are too brittle and do not comply with surface quality requirements.

Coextrusion can produce sheets with impact-resistant outer layers and with stiff core materials. However, the surface quality achieved in the injection process is impaired during the process of three-dimensional thermoforming to give final contours via vacuum thermoforming.

The forming of fabrics composed of thermoplastic material may take place according to a variety of processes. One process is EP 0303 710 B1 on a fabric or film composed of crystalline and non-crystalline regions. It is achieved via immersion of a mould into a liquid metal bath, this being composed of an eutectic mixture with an eutectic melting point sufficiently high to be above the softening temperature of the thermoplastic film. After the forming process, the mould has to be removed from the moulding.

Another process for forming of fabrics composed of thermoplastic material is the fusible core technique, in which “sacrificial cores” are produced from a low-melting-point metal alloy and, in a second operation, are inserted into an injection mould and used as a core for injection moulding. The resultant cores are removed by melting in an oil bath in a third operation, thus giving hollow bodies, e.g. outlet pipes.

The processes mentioned are technically fairly complicated, and the quality of the products does not comply with current requirements.

Another known process is vacuum thermoforming, which preheats the sheets prior to thermoforming in the thermoforming equipment. This process has surface-quality disadvantages via possible replication of suction bores or dust particles on the surface of the moulded sheet, and its procedure is relatively complicated, as described at a later stage below.

Unpublished preliminary experiments via forming in a press have shown that good surface quality is achieved even when the pressure on the heated extrudate is relatively low. The problem here is that the pressures on the areas relevant to the contours are not constant.

### SUMMARY OF THE INVENTION

One aspect of the present invention is to use a novel forming process to form plastics sheets, in particular coextruded sheets or sandwich sheets, in such a way as to achieve high precision of contours and a good surface. The present invention minimizes or avoids the disadvantages of the known processes.

According to the present invention, the method of achieving the aspect is that the trimmed coextrusion sheets (sandwich sheets) are inserted into a heated forming mould and heated by means of a temperature-controlled liquid, in particular a molten metal (eutectic metal alloy) by way of a pressure chamber, and formed with exposure to rising uniform pressure.

Another aspect of the present invention provides a process for the moulding of plastics sheets, using a two-part moulding tool, via insertion of the sheet into the moulding tool, closure of the moulding tool, thermoforming of the sheet with exposure to pressure and heat, with shaping against the interior contours of the moulding tool, and cooling of the thermoformed sheet, characterized in that the pressure side of the sheet is treated with a temperature-controlled liquid, in particular with a molten metal or with silicone oil, particularly preferably with a molten metal.

A preferred process is characterized in that the plastics sheet is based on unreinforced or reinforced thermoplastic, in particular selected from the following series: polyamide, polyester, preferably polybutyl terephthalate (PBTs), polycarbonate, polypropylene, ABS, thermoplastic polyurethane and mixtures of these polymers.

A particularly preferred process is characterized in that the plastics sheet is an extruded sheet, in particular a multilayer sheet (sandwich sheet).

Further preference is given to a process characterized in that the extruded sheet used in the process is taken directly from an upstream extrusion process.

Another preferred variant of the process is characterized in that the plastics sheet is preheated prior to the thermoforming process, in particular via radiative heating, particularly preferably by means of IR radiation.

It is preferable that the process utilizes a forming tool in which one side (contoured side) forms the cavity of the item to be moulded and the other side forms a pressure chamber (pressure-chamber side) with aeration and deaeration, and also with adapters for introduction of the melt.

In one preferred mould, the contoured side of the moulding tool is temperature-controlled to 50-130° C. in the manner usual for injection moulding, and depending on the metal alloy used, the pressure-chamber side is heated to 140-250° C. By way of example, the tool is opened and closed on a commercially available hydraulic press, and the production and introduction of the molten metal uses a commercially available casting system with gear pump.

The forming of thermoplastic sheet in the form of compact sheet or else coextruded sheet takes place, for example, but not limited to, on vacuum thermoforming machines, where the sheets are received within a clamping frame of the thermoforming machine and can be brought to forming temperature in the machine via radiative heaters, from below or above, or else on both sides.

To avoid premature contact of the heated sheet material with the cold mould (thermoforming tool), the heated sheet can be preformed with support air, thus achieving better wall thickness distribution in the thermoformed product.

In many instances, the known thermoforming tools are male moulds, the precisely contoured surface thus forming the inner side of the item, while the outer side reflects all of the wall-thickness differences resulting from the thermoforming procedure.

If precisely contoured visible surfaces are needed, female moulds are used. That means: there can sometimes be images of suction bores on the visible side, and the mould cavity surface of the thermoforming tool has to have a certain degree of roughness so that all of the air can be sucked out of the mould cavity. Thus, further operations are needed to produce surfaces that can be lacquered.

In known processes, the heat sources are withdrawn after the preheating of the sheets, and circulation of air here affects both the pre-blowing procedure and the dimensioning of the heated sheets; dust particles can also obtain access to the sheets (surface defects).

After the sheets have been heated, the thermoforming tool is brought towards the clamping frame, and seals the space between sheet and tool. This applies to male tools and also to female tools.

The forming procedure is generated via vacuum, or else more rarely compressed air, using an appropriate upper ram, and is difficult to control.

Once the heating elements have been withdrawn, the plastics sheet undergoes severe cooling, and continued upper heating is therefore used in the case of male moulds which are not excessively high or in the case of female moulds.

Processing latitude in vacuum thermoforming continues to be very small, despite improved machine technology in relation to heating and sequences of movements, and the surface quality of the product is unsatisfactory. The downstream operations, such as the cutting of the contoured materials and attachment of functional elements, often require much manual work.

The present inventive process avoids the disadvantages mentioned, and also permits the processing of relatively complex sheet structures.

The present inventive process is a specialized process for the forming of those thermoplastic sheets whose forming is difficult or impossible with the known machinery for vacuum forming. Among these are, in particular, but not limited to, coextruded sheets with mineral-filled or fibre-reinforced core components and with unfilled outer layers using, for example, glass-fibre reinforced polycarbonate (GRPC) as core component and polycarbonate/polybutylene terephthalate (PC/PBT) blends as outer layers. However, among these products are also sheets using GRPBT, nylon-6 (GRPA6), polypropylene (GRPP) etc., as core components and using appropriate outer layers composed of polyesters, such as polybutylene terephthalate (PBT), polyamide PA, PA/ABS blends or polypropylene (PP).

The present inventive process is oriented, for example, but not limited to, towards the production of large-surface-area components for utility vehicles or cars, where the materials used nowadays may be mainly thermoset fibre composite materials.

Among these are panelling for the driver compartments of lorries, for bodies of lorries and buses, and also of rail vehicles.

The surface quality of the plastic sheets formed by the present inventive process provides advantages in the lacquering process, and the thermoplastic is easier to fabricate, and it is easier to supplement it subsequently with functional parts via bonding processes known in principle, e.g. via ultrasound, vibration welding or laser welding.

The advantages of the present inventive process and of its preferred embodiments are summarized, for example, but not limited to,
In a continuous process sequence with extrusion it is possible to utilize the intrinsic heat possessed by the coextruded sheets after the extrusion process.
Heat for the forming process is introduced from the start via the heated pressure-chamber side of the forming tool, and the heating time for the plastics sheet therefore becomes shorter.
Contact with the molten metal heats the plastics sheet uniformly over the entire area of moulding, without radiation losses.
The molten metal can specifically heat the peripheral region first (alongside the clamped edge of the sheet).
The pressure-forming process using the molten metal can be controlled via the fill rate of the pressure chamber.
The slower forming process and the uniform temperature across the entire sheet surface, combined with isobaric pressure conditions in liquids, can achieve more uniform wall thickness distribution in the plastics moulding.
Forming is possible at lower sheet temperatures, enabling achievement of shorter cycle times for the production of the thermoformed sheets.
The slower forming process permits better escape of the air from the cavity, and post-treatment (e.g., sandblasting) of the tool surface is therefore not necessary (i.e., a better surface is obtained on the moulding).
Even plastics that are difficult to thermoform can be formed because heat is introduced during the forming process.

The invention is further illustrated below using the figures by way of example, which does not, however, restrict the invention.

### BRIEF DESCRIPTION OF THE DRAWINGS

FIG. 1 is a diagram of a cross section of the opened moulding system with a sheet supply unit;

FIG. 2 shows the opened forming tool with IR heating for the preheating of the sheet 7;

FIG. 3 shows the closed moulding tool from FIG. 1 with attached molten metal feed;

FIG. 4 shows the charging of molten metal to the circulation duct in the forming tool;

FIG. 5 shows the thermoforming of the sheet 7 in the forming tool via the molten metal;

FIG. 6 is a diagram showing the temperature distribution through a 4 mm sheet between melt and mould, as a function of contact time;

FIG. 7 shows the formed sheet 7 in the forming tool and the removal of the molten metal by pumping;

FIG. 8 shows the removal of the formed sheet 7 from the forming tool; and

FIG. 9 shows the trimming of the moulded semifinished product in a cutting device and the recommencement of the thermoforming cycle.

### DETAILED DESCRIPTION OF THE INVENTION

The plastics sheets, for example, but not limited to, coextruded sheets (with glass-fibre-reinforced polycarbonate (GRPC) as core material and a polycarbonate/polybutylene terephthalate mixture (PC/PBT) as outer layer) are cut to the shape of printed circuit boards directly from the coextrusion plant and transported by way of a conveyor belt 6 to the forming plant.

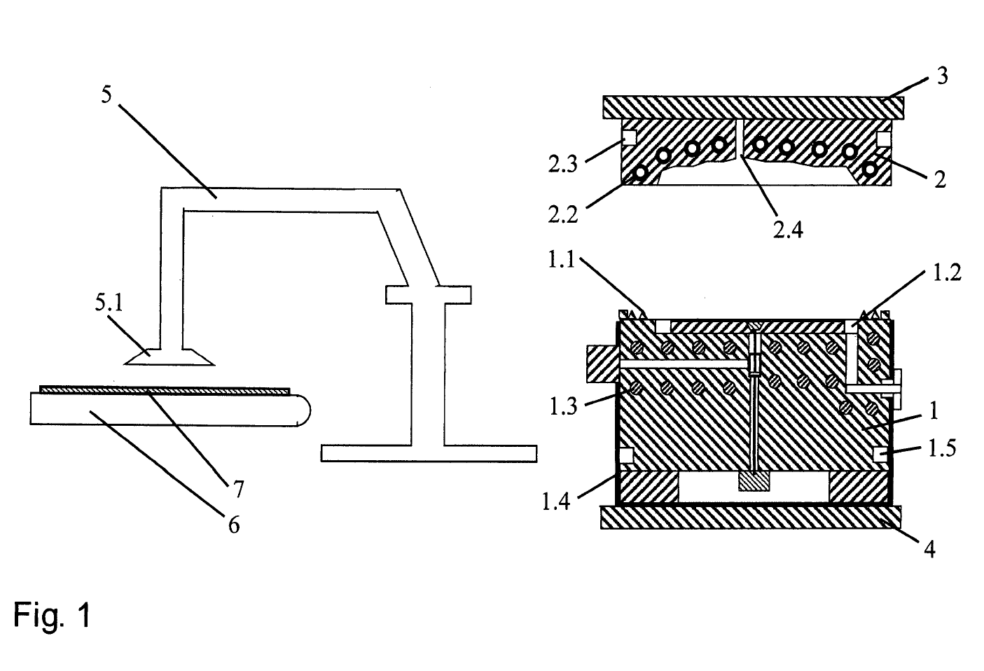

A gripper 5.1 of the lifter device 5 takes the sheet 7 from the conveyor belt 6 and places it on the pressure-chamber side 1 of the forming tool (FIG. 1). The edge on which the sheet is laid has teeth 1.1 which press into the surface of the coextruded sheet when the tool is closed and thus prevent withdrawal of the sheet during the forming procedure, at the same time acting as a labyrinth seal. The circulation duct 1.2 serves for the controlled introduction of the molten metal in the peripheral region of the pressure chamber, in order to counter the cooling effect resulting from the cooled female-mould side 2 of the tool.

Heating elements 1.3 are used for the temperature control of the pressure-chamber side 1, in order to maintain the tool temperature at melt temperature.

To reduce heat losses, side 1 of the tool is insulated on the outer sides and with respect to the machine plate 4 by thermally insulating sheets 1.4.

The pressure-chamber side 1 of the tool has connection to the press table 4 by way of mechanical or hydraulic clamping lugs, e.g., by way of a clamping groove 1.5.

The upper half 2 of the tool has the cavity 2.1 and the cooling bores 2.2 and has connection to the moving plate 3 of the press by way of the clamping grooves 2.3. A deaeration bore 2.4 has been provided for the deaeration of the cavity 2.1 during the forming process, and can also be opened and closed by way of a needle valve (not shown), thus minimizing any visible marking on the moulding.

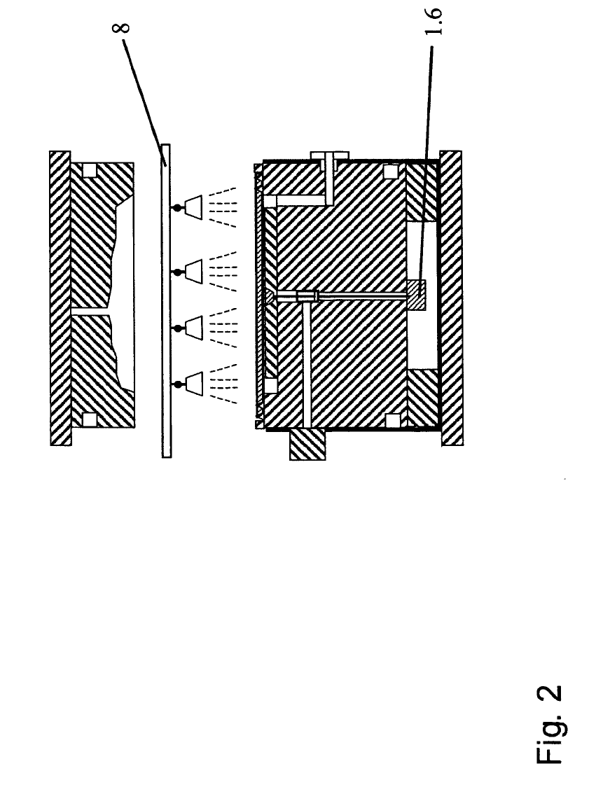

Once the composite sheet 7 has been inserted, an additional heating system 8 using infrared sources may be moved into the open tool, where appropriate, providing additional heat to the sheet 7 on the surface oriented towards the contoured side (FIG. 2). A continuous process may also utilize the thermal capacity of the sheets 7 after the extrusion process, in order to eliminate preheating. The heating of the pressure side of the sheet 7 by way of the heated tool begins before the closure procedure has ended. The vacuum valve 1.6 initially remains closed.

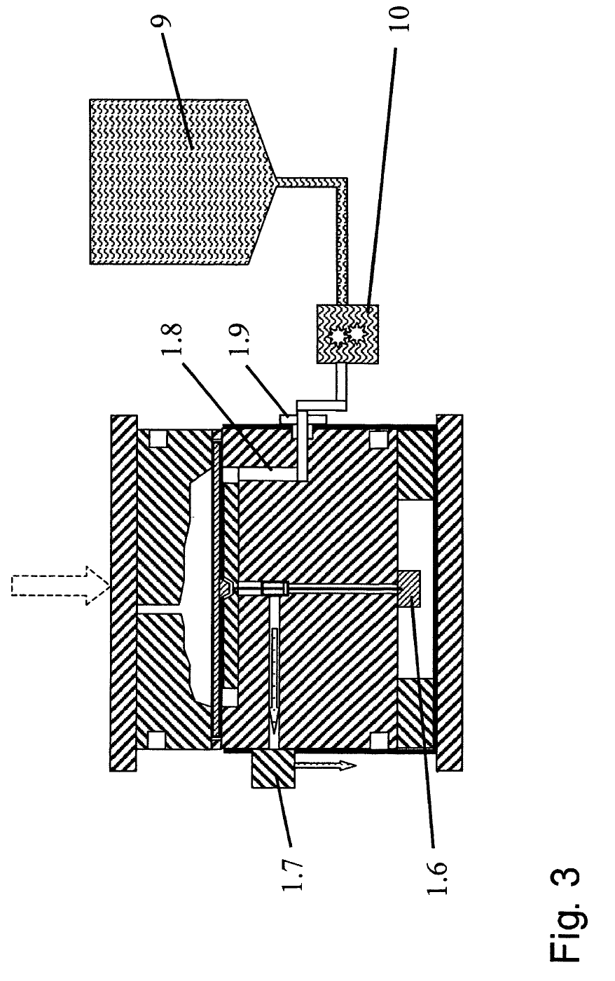

FIG. 3 shows the closed tool. The valve 1.6 must be opened and the vacuum pump 1.7 sucks the air from the melt or from the pressure chamber below the coextruded sheet. This process also deaerates the melt-feed ducts 1.8.

The container 9 is a commercially available system for melting low-melting-point metal alloys and provides the molten metal needed for the forming process. The gear pump 10 pumps the molten metal into the pressure chamber of the closed forming tool. The connecting lines between container 9, gear pump 10 and feed duct 1.8 are heated to keep the molten metal liquid. The adapter 1.9 comprises a shut-off nozzle and the attachment for the melt line.

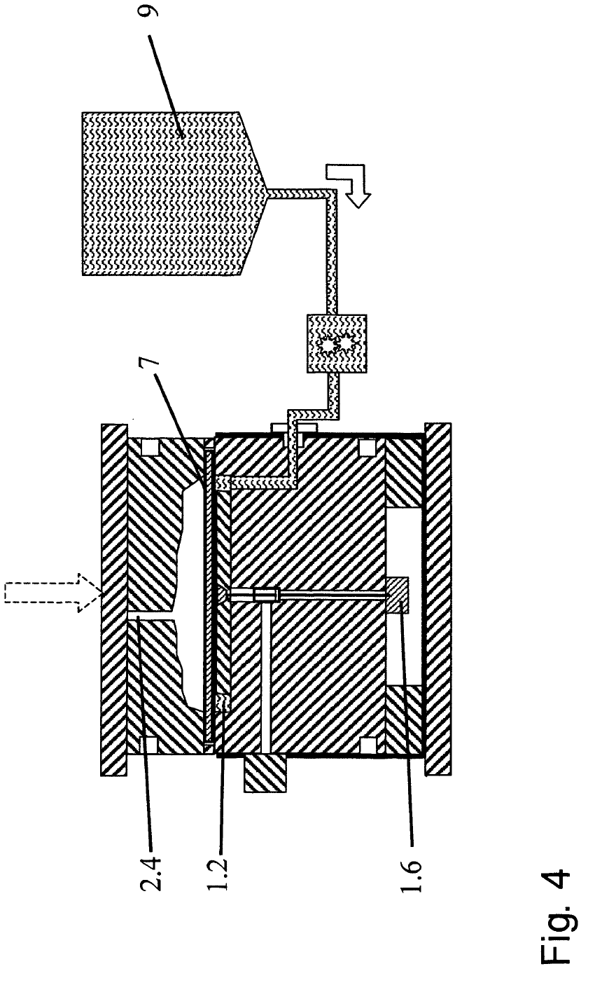

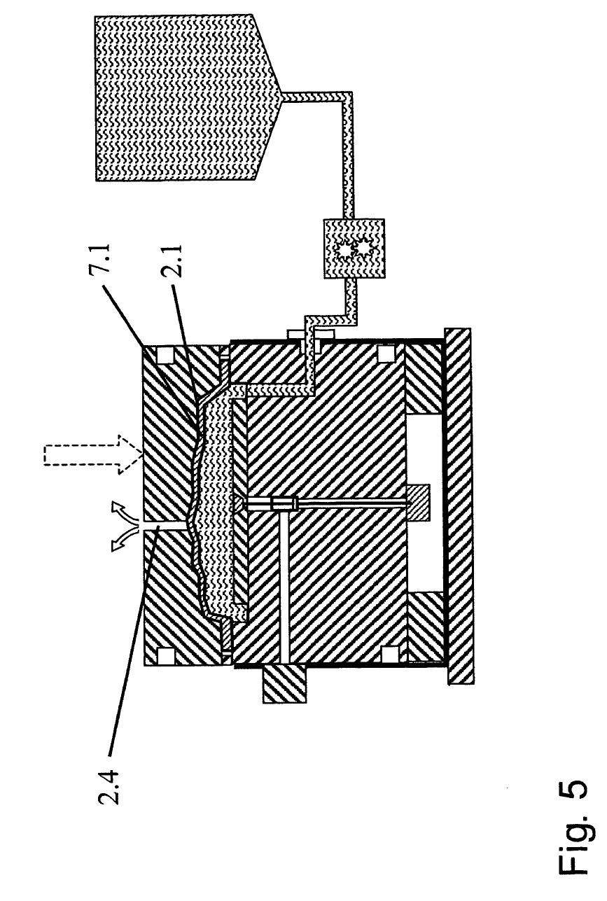

The molten metal can be charged in stages via appropriate control of the gear pump. First, the material is charged to the circulation duct 1.2 of the melt chamber, the result being preferred heating of the sheet 7, starting at the clamped edge (FIG. 4). The valve 1.6 has been closed. An appropriate retention time can give controlled heating of the peripheral region. The sheet 7 is also heated by way of the contact with the tool wall of the pressure chamber. In the next step, the molten metal is pumped into the pressure chamber until the entire plastics sheet 7.1 is in contact with the wall of the tool cavity (see FIG. 5). The air present in the cavity 2.1 can escape by way of the deaeration bore 2.4.

The gear pump, or an intermediate hydraulic piston pump (not shown), can generate a pressure >10 bar and permits variation of the charge rate, thus permitting the forming procedure to take place slowly, rather than suddenly as in the vacuum process. An advantage of this is that the plastics sheet 7 is constantly maintained in tension and is constantly heated by way of the molten metal.

The plastics sheet 7 can therefore undergo thermoelastic relaxation or thermoelastic creep. In addition, the molten metal generates a constant temperature across the entire contact area during the forming process.

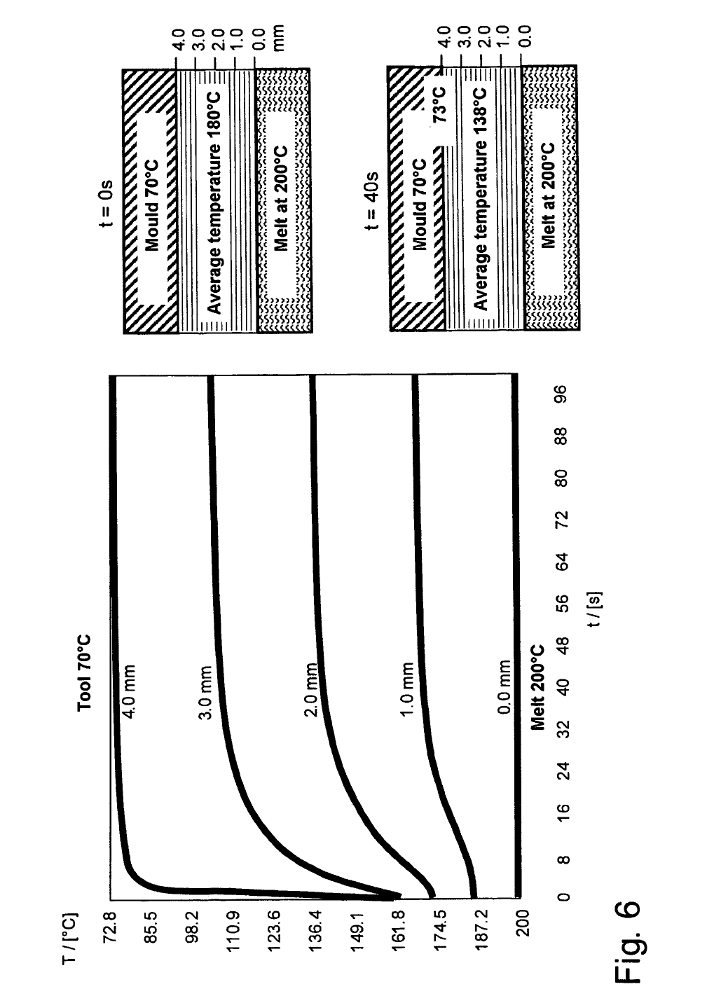

As soon as the plastics sheet enters into contact with the cavity 2.1 in the cooled contoured side 2 of the forming tool, a steep temperature gradient is produced within the cross section of the sheet. FIG. 6 gives a calculated diagram with the temperature distribution across a 4 mm sheet between molten metal (200° C.) and mould (70° C.) as a function of the time of contact between melt and sheet.

Under conditions of pressing of the formed plastics sheet 7 by the molten metal onto the contoured plate, the average sheet temperature falls from 180° C. to 138° C. within 40 s. The temperature of the molten metal in this instance is 200° C. and the temperature of the contoured side 2 of the tool is 70° C.; the sheet thickness is 4 mm.

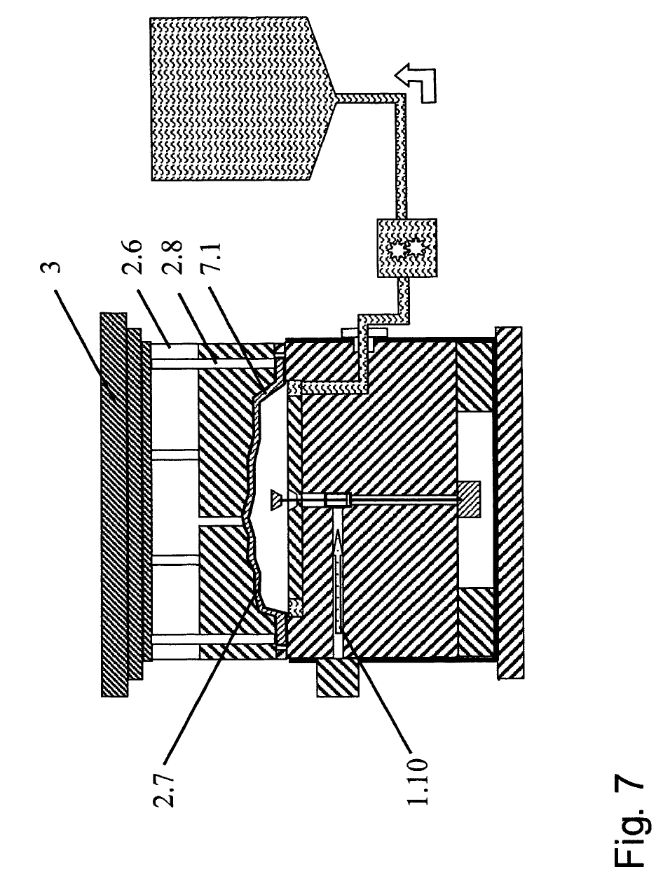

This means that the formed plastics sheet has sufficient intrinsic stiffness and retains the intended contours. The tool also provides the possibility of introducing compressed air or nitrogen by way of the deaeration suction bore 1.10, for additional cooling of the pressure-chamber side of the plastics moulding, once the molten metal has been pumped out (FIG. 7).

To promote the demoulding of the plastics moulding, the contoured side 2 of the tool may be provided with an ejector box and ejector plates with appropriate ejector pins 2.8.

During opening of the tool, the ejector plates may be advanced hydraulically or pneumatically at the rate of opening of the press, thus keeping the moulding 7.1 on the pressure-chamber side 1 of the tool.

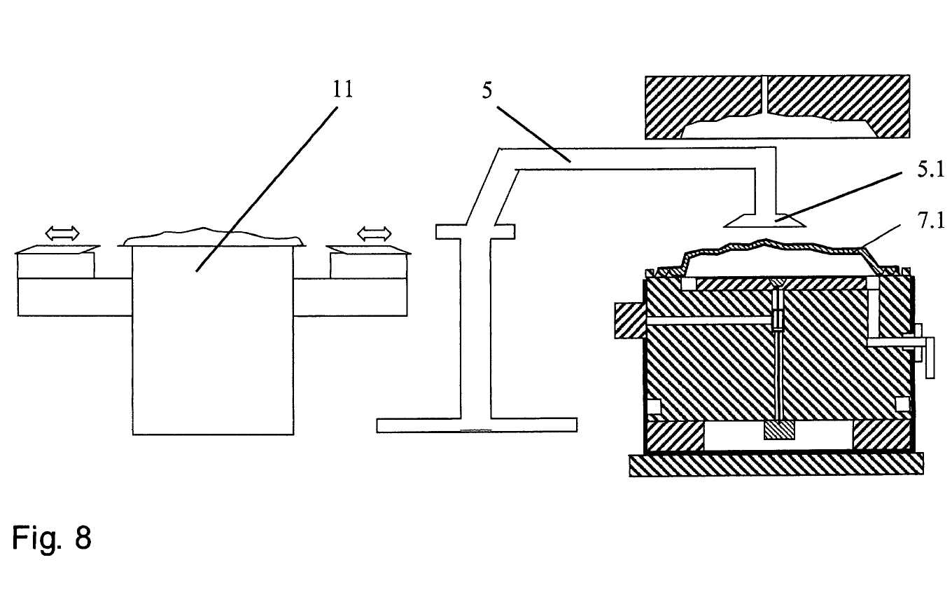

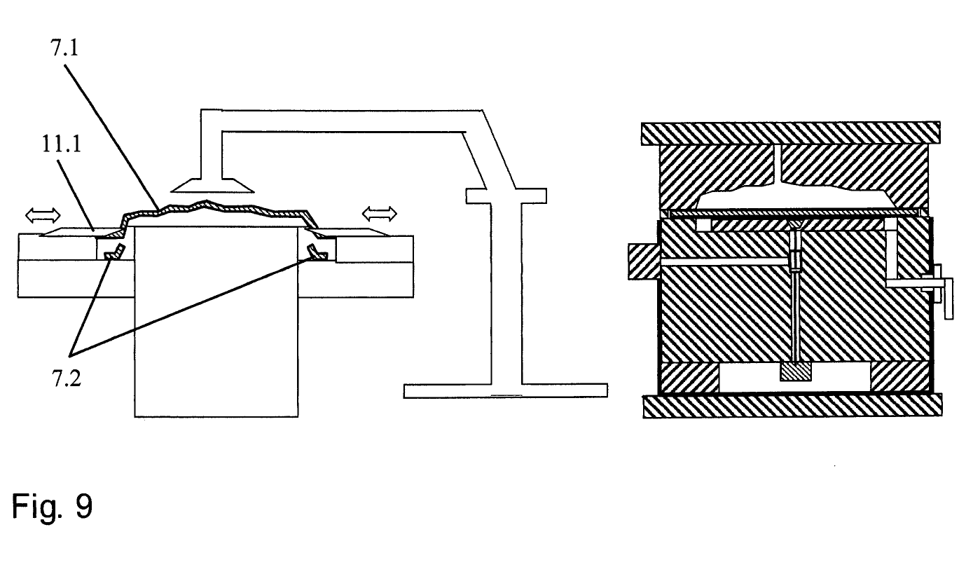

Once the tool has been opened (see FIG. 8) the moulding 7.1 is removed by way of the suction lifter 5.1 of the lifting device 5 and introduced into a cutting tool 11. The edge-cutting of the thermoformed sheet 7 may take place mechanically, for example, shown here and in FIG. 9,—or other appropriate mechanical means such as a water jet or laser technology.

Simultaneously, the moulding tool receives another composite sheet and is closed (FIG. 9).

The edge-cutting 7.2 takes place in the example by way of movable sliding cutters 11.1, which carry out the edge-cutting sequentially as required by the geometry of the moulding.

The edge-cut 7.2 is removed and comminuted and returned to the extrusion process for the core component of the coextruded plate.

Although the invention has been described in detail in the foregoing for the purpose of illustration, it is to be understood that such detail is solely for that purpose and that variations can be made therein by those skilled in the art without departing from the spirit and scope of the invention except as it may be limited by the claims.

1. Process for the moulding of plastics sheets, using a two-part moulding tool, via insertion of a sheet into the moulding tool, closure of the moulding tool, thermoforming of the sheet with exposure to pressure and heat, with shaping against the interior contours of the moulding tool, and cooling of the thermoformed sheet, wherein the pressure side of the sheet is treated with a temperature-controlled liquid.

2. Process according to claim 1, wherein the plastics sheet includes a thermoplastic selected from the group consisting of polyamide, polyester, PBT, polycarbonate, polypropylene, ABS, thermoplastic polyurethane and mixtures thereof.

3. Process according to claim 1, wherein the plastics sheet is an extruded sheet or a multilayer extruded sheet.

4. Process according to claim 3, wherein the extruded sheet used in the process is a coextruded sheet with mineral-filled or fibre-reinforced core components and with unfilled outer layers, preferably with glass-fibre-reinforced polycarbonate (GRPC), polybutylene terephthalate (GRPBT), nylon-6 (GRPA6), polypropylene (GRPP) as core component and polyesters, in particular polybutylene terephthalate (PBT), polyamide PA, PA/ABS mixtures or polypropylene (PP) as outer layer.

5. Process according to claim 3, wherein the extrusion sheet used in the process is taken directly from an upstream extrusion process.

6. Process according to claim 1, characterized in that the plastics sheet is preheated prior to the thermoforming process, in particular via radiative heating, particularly preferably by means of IR radiation.

7. Process according to claim 1, wherein the process utilizes a forming tool including a first side forming the cavity of the item to be moulded and ascend side forming a pressure chamber with aeration and deaeration, and adapters for introduction of the melt.

8. Process according to claim 1, wherein the moulding tool includes a contour side and a pressure-chamber side and, prior to the thermoforming process, the contoured side is heated to 50-130° C. and the pressure-chamber side is heated to 140-250° C.

9. Process according to claim 1, wherein the temperature-controlled liquid is a molten metal or a silicone oil.

10. Process for the moulding of plastics sheets, comprising:
using a two-part moulding tool;
inserting a sheet into the moulding tool;
closing the moulding tool;
thermoforming of the sheet with exposure to pressure and heat;
shaping against the interior contours of the moulding tool; and
heating the contoured side of the moulding tool to a temperature less than the pressure-chamber side.
